(19) United States
(12) Patent Application Publication
(10) Pub. No.: US 2024/0148028 A1
(43) Pub. Date: May 9, 2024

(54) Biodegradable Edible Stirrers

(71) Applicant: Tahndanya Johnson, Moreno Valley, CA (US)

(72) Inventor: Tahndanya Johnson, Moreno Valley, CA (US)

(21) Appl. No.: 17/679,140

(22) Filed: Feb. 24, 2022

(51) Int. Cl. A23L 2/56; A23L 2/60; A23L 27/00; A47G 21/00

(52) U.S. Cl. CPC A23L 2/56; A23L 2/60; A23L 27/70; A47G 21/004

(57) ABSTRACT

Various embodiment of a biodegradable elongated formatted implement for blending beverages and integrating flavors. The implement is made of a compacted edible substance and degradable substance that will dissolve upon liquid contact. The implement has the means to flavor or cool beverages. The implement degradable and dissolvable features decreases environmental waste derived from indissoluble stirrers.

### TECHNICAL FIELD

This invention relates to beverage stirrers. To be more specific, this intervention pertains to biodegradable stirrers.

### BACKGROUND

Traditional stirrers are commonly processed from materials that are toxic and non-biodegradable. With luck, disposable and reusable stirrers made from harsh materials such as plastic, metal, and glass will eventually be wind up in landfills. However, these stirrers often find their way into the environment, where they harm and contaminate wildlife and their habitats. The 2017 video of a plastic straw caught up the sea turtle nostril exemplifies the negative environmental impact waste has on wildlife. Unfortunately, some stirrers are made of non-biodegradable materials, so they reside in the environment for several months and sometimes years, which increases the potential to harm wildlife.

Furthermore, sometimes traditional stirrers are not suitable for warm or hot beverages because the material breaks down when exposed to elevated temperatures. This can potentially lead consumers to ingest toxic materials such as plastic or metal.

In addition, traditional stirrers do not offer a means for cooling warm beverages such as coffee and tea. This urges the consumer to add something like ice to cool their beverage, which in turn causes the beverage to become watered-down.

Therefore there exists a need for a stirrer that decreases landfill waste, environmental pollution, and toxin exposure while also being able to blend the flavors of a beverage and cool a beverage if necessary.

### Problems with Current Art

1. Stirrers made from plastic, glass, and metals contribute to environmental and wildlife pollution.
2. Stirrers made from plastic, glass, and metals are toxic and harmful to the environment and wildlife.
3. Stirrers made from plastic, glass, metals, and other materials unnecessarily contribute to landfill waste.

### BRIEF DESCRIPTION OF DRAWINGS

Note: For simplicity of illustration, the implement is depicted as a cylindrical rod. When the rod is shown it is purely for illustrative purposes and not intended to capture all embodiments of the invention disclosed.

FIG. 1 Is a front view of the user submersing the stirrer in a beverage.

FIG. 2 Is a front view of the user mixing the beverage with the stirrer.

FIG. 3 is a front view of the user mixing the beverage with the stirrer and the stirrer beginning to break down into particles.

FIG. 4 Is a front view of the particles mixing and dissolving into the beverage and the user holding the undissolved portion of the stirrer.

FIG. 5 Is a front view of the particles completely dissolved in the beverage and the user holding the undissolved portion of the stirrer.

### DETAILED DESCRIPTION OF INVENTION

An embodiment of a biodegradable elongated formatted implement for blending flavors and integrating flavors:

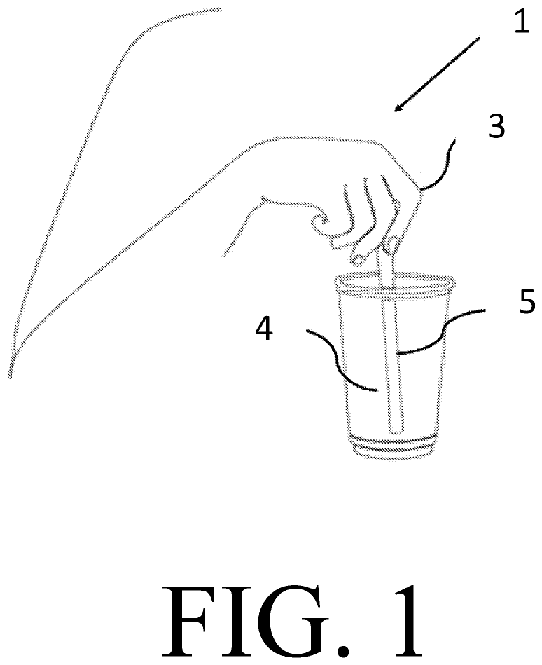

An embodiment of a biodegradable elongated formatted implement 1 is illustrated all or in part in FIGS. 1-5. Referring primarily to FIG. 1, in this embodiment, user 3 is depicted submersing the biodegradable implement 5 in a beverage 4.

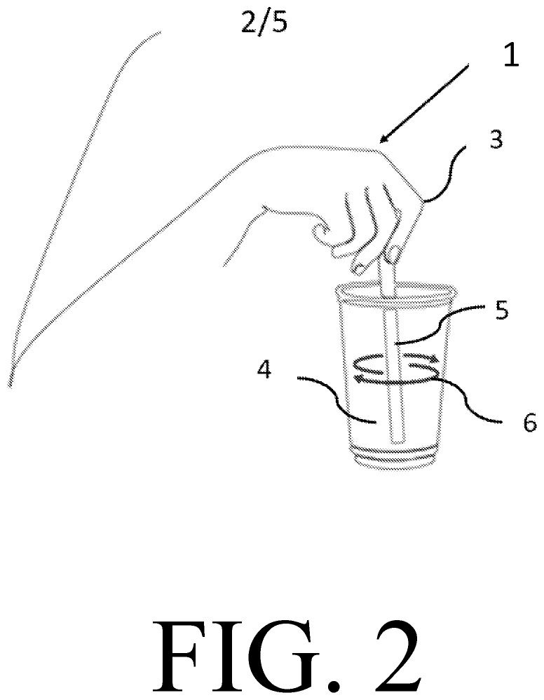

Referring primarily to FIG. 2, an embodiment from a front view depicting user 3 manipulating the biodegradable implement 5 in a stirring motion 6 to mix the beverage 4.

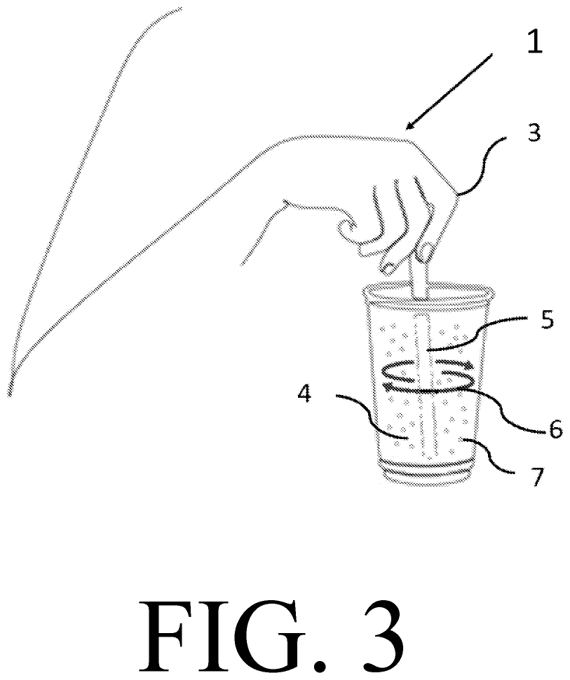

Referring primarily to FIG. 3, an embodiment from the front view illustrating the biodegradable implement 5 dissolving into particles 7

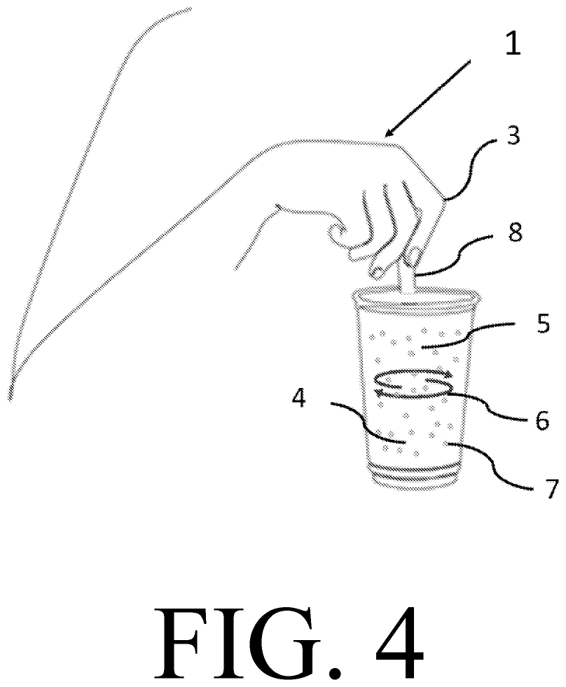

Referring primarily to FIG. 4, an embodiment from the front view illustrate that the submerged portion of the biodegradable implement 5 is completely broken up into particles 7. FIG. 4 further depicts the user holding the undissolved portion of the biodegradable implement 8.

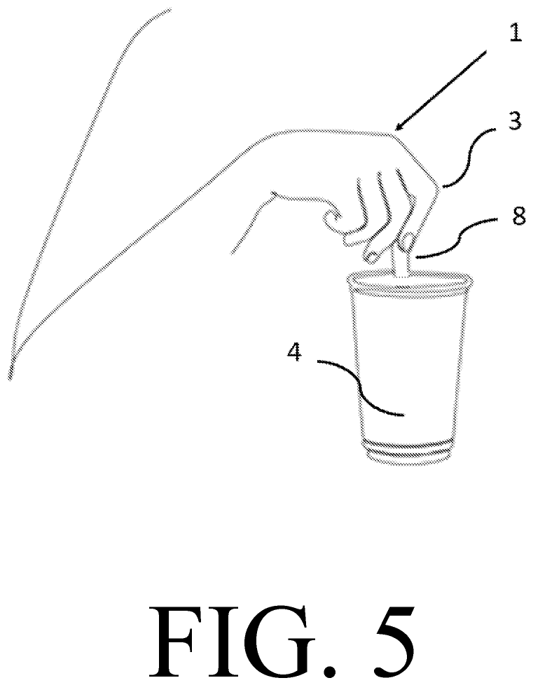

Referring to FIG. 4 and FIG. 5, an embodiment from the front view illustrates the infusion of particles 7 in beverage 4.
1. A unique stirrer that is entirely constructed of a safe, edible, and biodegradable substance.

The invention claimed is:

1. An embodiment of a biodegradable elongated formatted implement for blending beverages and integrating flavors comprising essentially of:

2. An edible substance; and a degradable substance
1. The implement of claim 1, wherein said implement is made entirely of a dissolvable substance.
2. The implement of claim 1, wherein said implement is made entirely of a compacted edible substance.
3. The implement of claim 1, further comprising a means for multiple combinations of flavorings, creamer, sweeteners and sweetener substitute, or flavoring or creamer or sweetener or sweetener substitute to flavor beverages.
4. The implement of claim 1, further comprising a means for cooling beverage.

3. An implement made entirely from a biodegradable substance for eliminating environmental waste derived from indissoluble stirrers.
